(19) United States
(12) Patent Application Publication
(10) Pub. No.: US 2002/0193943 A1
(43) Pub. Date: Dec. 19, 2002

(54) Automatically orientated electronic map

(75) Inventor: Martin Hennelly, Reading (GB)

Correspondence Address: SUGHRUE MION, PLLC, 2100 Pennsylvania Avenue, NW, Washington, DC, 20037-3213, US

(73) Assignee: NEC CORPORATION

(21) Appl. No.: 10/171,969

(22) Filed: Jun. 17, 2002

(30) Foreign Application Priority Data
Jun. 19, 2001 (GB) 0114923.6

(51) Int. Cl. G01C 21/30

(52) U.S. Cl. 701/208; 340/990; 340/995

(57) ABSTRACT

An apparatus for displaying an electronic map comprises a positioning system, means to access map databases, an electronic compass, a processor and a display screen. The processor receives data from the positioning unit, the electronic compass and a map database and causes an electronic map to be displayed on the display screen such that north on the map is always aligned with true (geographic or magnetic) north.

### BACKGROUND OF THE INVENTION

1. Field of the Invention

The present invention relates to an apparatus for displaying an electronic map, in particular to an electronic map which is automatically displayed with north on the map aligned with true north (geographic or magnetic).

2. Description of the Related Arts

There are many disclosures in which geographical maps are displayed on electronic devices. Furthermore, positioning systems are also well known in which the position of a device can be established to within a few meters. These can be based on the GPS (Global Positioning System). Mobile phones can also be provided with systems that pick up position information with the mobile phone network. These concepts have previously been combined to display a map centered around the present location of the device. These have been installed on hand held devices and also in aircraft and motor vehicles as part of navigation systems. Conventionally, these devices display the map in a fixed static orientation with respect to the device, in general with north corresponding to the top of the device.

Electronic compasses are also well known. In general, electronic compasses are used to display the bearing between true north and the direction in which the axis of the device is pointing. These compasses are used as an alternative to more traditional needle compasses.

Devices have been disclosed which combine these three features to display a map of the local area and indicate the angle in which the device is pointing with respect to true north using an electronic compass.

Generally, when reading a map the user will rotate the map such that north on the map is aligned with true north. Therefore, when using an electronic map with a fixed orientation with respect to the display screen the user is required to rotate the device to line up true north with the axis of the device. This becomes problematic if the user wishes to read the map while moving since he must constantly rotate the device in order that the map remains correctly aligned with true north. This can also have the disadvantage that the direction of travel is unclear or the relation of the map direction to the present direction is unclear. Furthermore, this makes the device uncomfortable to hold since the device is not held in its conventionally designed orientation. It may also be difficult to manually align true north with the map.

### SUMMARY OF THE INVENTION

An object of the present invention is to provide an apparatus for displaying an electronic map in which the electronic map is automatically displayed with north on the map aligned with true north.

According to the present invention there is provided an apparatus for displaying an electronic map comprising a positioning unit, means to access a map database, an electronic compass, a processor and a display screen, wherein the processor receives data from the positioning unit, the electronic compass and the map database and causes a map to be displayed on the display screen such that north on the map is always aligned with true (geographic or magnetic) north.

Preferred embodiments of the present invention alleviate these problems by providing a device for displaying an electronic map in which north on the map is automatically aligned with true north.

The device according to the present invention contains a positioning system to calculate the geographical coordinates of the device and is then able to access local map data either from maps stored at local base stations, maps stored within the memory of the device or maps accessible and downloadable via a network. Furthermore the device contains an electronic compass. The device combines data from the local map and the electronic compass to automatically orientate the map such that north on the map is always aligned with true north. This alleviates the need to manually rotate the device in order to align the map with true north.

### BRIEF DESCRIPTION OF THE DRAWINGS

A preferred embodiment of the present invention will now be described with reference to the accompanying drawings in which;

FIG. 1 is a block diagram showing an apparatus for displaying an electronic map according to an embodiment of the present invention;

FIG. 2 is a flow diagram showing the procedure followed by the processor for displaying an aligned map in the embodiment of the present invention;

FIG. 3A is view of the display in an embodiment of the device in a first orientation;

FIG. 3B is a view of the display in an embodiment of the device in a second orientation; and

FIG. 3C is a view of the display in an embodiment of the device in a third orientation.

### DETAILED DESCRIPTION OF THE INVENTION

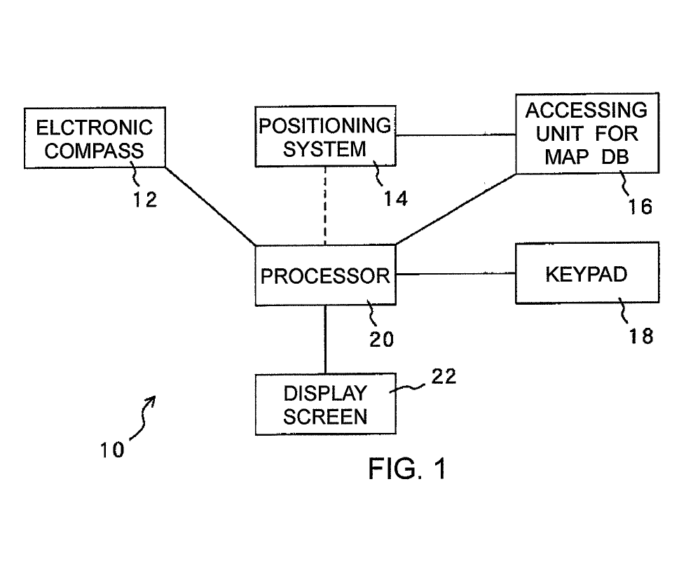

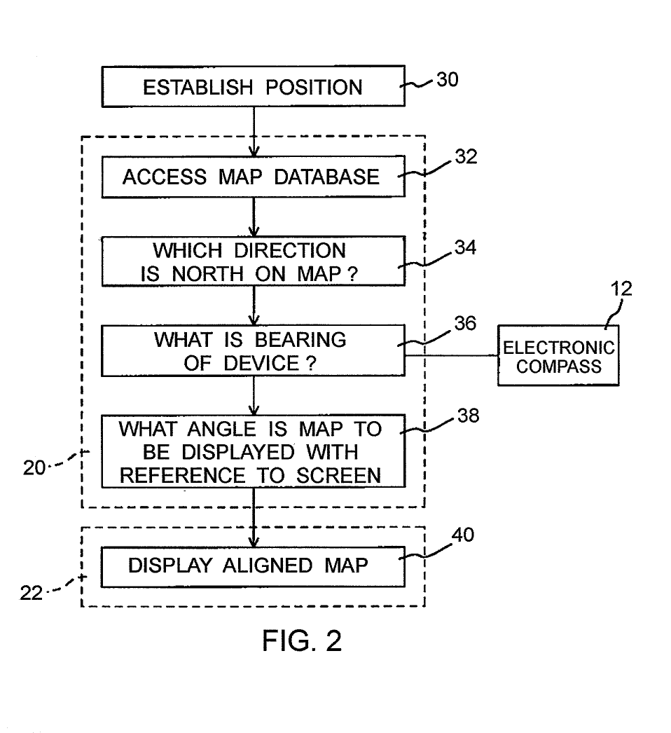

The block diagram of FIG. 1 shows the components of a device according to an embodiment of the present invention which may be provided in a mobile phone and displays an electronic map. The device 10 for displaying an electronic map includes an electronic compass 12, a positioning system 14 such as a GPS receiving unit, accessing unit 16 for map database (DB), keypad 18 and processor 20. The electronic compass 12 calculates the bearing on which the device 10 is pointing and hence the angle between the orientation of the device 10 and true north. The positioning system 14 accurately establishes the coordinates of the device 10. The accessing unit 16 accesses a map database and provides local map data. The keypad 18 enables the user to input control data. Each of these constituents are linked to the processor 20 although the positioning system 14 is linked to the processor 20 via the accessing unit 16 for map database. By the process described in FIG. 2, the processor combines the data and displays the correctly orientated map on the display screen 22.

In a preferred embodiment the map database is accessed through a network via local base stations as the device 10 is moved between areas although maps of local areas could be downloaded onto the memory of the device 10 or be accessed via an alternative means.

The flow diagram of FIG. 2 shows the procedure followed by the device 10 for displaying the orientated map on the display screen 22 of the device 10.

The geographic co-ordinate positions of the device 10 are first established by the positioning system at box 30. The geographic co-ordinates of the device 10 are then forwarded to the map database which uses the coordinates to access a region of the map local to the device 10 at box 32. In a preferred embodiment, a region of the map is accessed within a defined radius from the position of the device 10. The local region of the map is then forwarded to the processor 20.

On receiving the map from the database at box 34, the processor 20 is made aware which direction is north on the map. The bearing at which the device 10 is pointing with respect to geographic north is independently forwarded to the processor 20 from the electronic compass 12 at box 36.

The processor 20 calculates the angle between the direction in which the device 10 is pointing and true north from the bearing forwarded by the electronic compass 12 at box 38. The processor 20 then calculates at what angle it is required to display the map with respect to the display screen 22 to ensure that north on the map is aligned to true north. The processor 20 forwards this information to the display screen 22 and the map is displayed in the correct orientation to the user at box 40.

In general, the present invention is employed in devices which are mobile. Therefore the position of the device and bearing on which the device is pointing are regularly monitored by the positioning system and electronic compass respectively to account for the motion of the device. The bearing is forwarded directly to the processor and the GPS coordinates are forwarded to the processor via the accessing unit 16 for map database by the process described in FIG. 2. The processor forwards the updated information to the display screen multiple times per second to ensure the map on the screen is always correctly orientated.

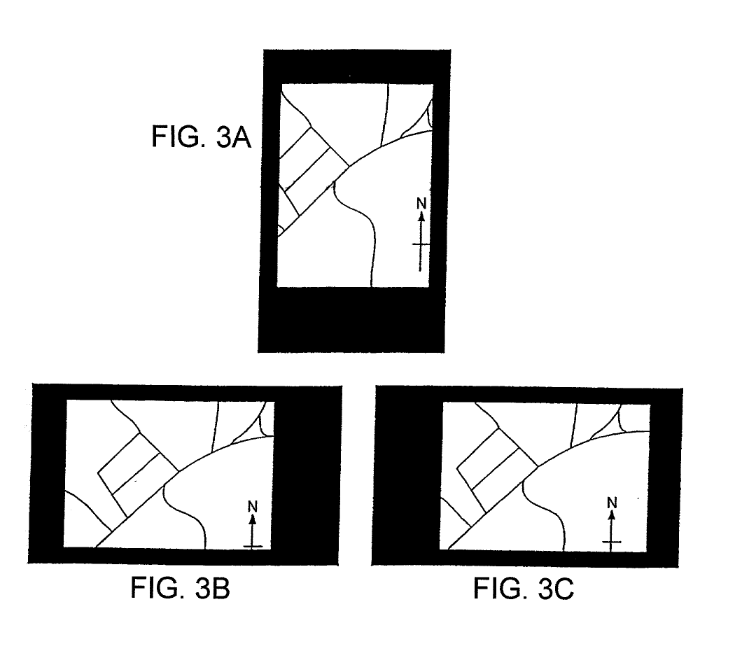

FIGS. 3A to 3C show views of the display in an embodiment of the device at a fixed geographical coordinate at various rotations. The figures show that as the orientation of the device is changed the map displayed on the screen rotates relative to the device such that north on the map is always aligned with true north.

The apparatus for displaying an electronic map according to the present invention is provided with a plurality of operating modes. In a first operating mode, the display screen displays the map with the device at the center of the map. In a second operating mode the device can lock the position of the map with respect to the screen such that the device performs in the more conventional way.

The scale of the map displayed on the screen is controlled by the user via the keypad. The user is able to “zoom” in or “zoom” out of the map in order to magnify or increase the viewable region of the map.

A further operating mode enables the route traveled by the device to be marked on the display.

The user is also able to add landmarks to the map by entering the coordinates via the keypad.

While preferred embodiments of the present invention have been described using specific terms, such description is for illustrative purposes only, and it is to be understood that changes and variations may be made without departing from the spirit or scope of the following claims.

What is claimed is:

1. An apparatus for displaying an electronic map comprising:
a positioning unit;
means to access a map database;
an electronic compass;
a processor; and
a display screen;
wherein the processor receives data from the positioning unit, the electronic compass and the map database and causes a map to be displayed on the display screen such that north on the map is always aligned with true north.

2. An apparatus for displaying an electronic map as in claim 1, wherein said true north is one of geographic north and magnetic north.

3. An apparatus for displaying an electronic map as in claim 1, wherein geographical coordinates of said apparatus are displayed at a fixed point on the display screen.

4. An apparatus for displaying an electronic map as in claim 1, wherein the map database is accessed via a local base station.

5. An apparatus for displaying an electronic map as in claim 3, wherein the map database is accessed via a local base station.

6. An apparatus for displaying an electronic map as in claim 1, wherein geographical coordinates of said apparatus obtained by said positioning unit is forwarded to said map database, a region of the map database is accessed within a defined radius from a position of the apparatus, and a local region of a map is forwarded to the processor from the map database.

7. An apparatus for displaying an electronic map as in claim 3, wherein the geographical coordinates by said positioning unit is forwarded to said map database, a region of the map database is accessed within a defined radius from a position of the apparatus, and a local region of a map is forwarded to the processor from the map database.

8. An apparatus for displaying an electronic map as in claim 1, wherein scale of the map on the display screen is controllable by an user.

9. An apparatus for displaying an electronic map as in claim 3, wherein scale of the map on the display screen is controllable by an user.

10. A mobile telephone including an apparatus according to claim 1.

11. A mobile telephone including an apparatus according to claim 3.

12. A mobile telephone including apparatus according to claim 8.
